(19) United States
(12) Patent Application Publication
(10) Pub. No.: US 2007/0121841 A1
(43) Pub. Date: May 31, 2007

(54) Speed Dialing in Calling Card Telephone Services

(76) Inventor: Jong Phil Shin, Fort Lee, NJ (US)

Correspondence Address: JAMES D IVEY, 3025 TOTTERDELL STREET, OAKLAND, CA, 94611-1742, US

(21) Appl. No.: 11/551,638

(22) Filed: Oct. 20, 2006

Related U.S. Application Data
(60) Provisional application No. 60/728,998, filed on Oct. 20, 2005.

(51) Int. Cl. H04M 15/00

(52) U.S. Cl. 379/114.2

(57) ABSTRACT

Only one or two extra key presses are required to invoke such advanced telecommunications functions as speed dial number storage, speed dialing, ANI registration/de-registration, and account transfer/re-fill in a prepaid telephone account.

### RELATED APPLICATIONS

The present application claims priority of U.S. Provisional Patent Application S/N 60/728,998, filed Oct. 20, 2005.

### FIELD OF THE INVENTION

This invention relates to the field of telecommunications service and, in particular, to a mechanism for providing a particularly efficient user interface for enhanced services for pre-paid telecommunications service.

### BACKGROUND

The following background section is incorporated herein by reference from U.S. Pat. No. 6,873,690.

Prepaid telephone calling cards have been in wide use for making local and long distance telephone calls. These calling cards are typically sold in fixed value increments (e.g., $10, $20, etc.) at various distribution centers, such as retail stores. Because prepaid telephone calling card services are accessed with access codes (i.e., personal identification numbers or PINs) and do not hence require coins, prepaid calling cards are especially convenient for making telephone calls from public pay phones.

In order to make a telephone call with a typical prepaid calling card, a designated access telephone number (e.g., a 1-800 telephone number) is dialed by the cardholder for accessing an associated computerized calling system. When the call is connected to the calling system, the cardholder is prompted to enter the access code or PIN printed on the calling card. If the access code is correctly entered, the call is connected to a desired destination telephone number, and an appropriate charge is deducted from the account or balance associated with the access code.

While prepaid calling cards have been popular, there is a need to make additional improvements to enhance their usefulness and convenience. For instance, because each prepaid telephone call requires the entry of an access code, call processing is delayed.

Various prepaid telecommunication systems and methods have been developed (see, for instance, U.S. Patent Publication No. US 2001/0028705 A1 and U.S. Pat. Nos. 5,825,863, 6,188,752, 6,208,851 and 6,236,851). However, these systems and methods are believed to have limited applicability.

### SUMMARY OF THE INVENTION

In accordance with the present invention, a telephone server stores previously dialed telephone numbers associated with a prepaid user account using only one or two user input gestures. Normally, such conveniences typically require involved web-based interaction or multiple-transaction interactive voice response (IVR) dialogs. Web-based management of stored telephone numbers general requires a computer or other connected computing device, and such is frequently not available to people who need pre-paid phone services, e.g., people who are traveling or who otherwise have somewhat limited choices with respect to communications services. Complex IVR dialogs take time and effort and can result in storage of erroneously entered numbers, and such errors may not be detected until the stored telephone number is later recalled for dialing.

In accordance with the present invention, only one or two extra key presses are required to invoke such advanced telecommunications functions as speed dial number storage, speed dialing, ANI registration/de-registration, and account transfer/re-fill.

With respect to speed dialing, the user's experience is as follows: First, the user places a telephone call using the prepaid service in a conventional manner. Any time during the call, the user can press and hold and of the numeric keys 1, 2, 3, 4, or 5 for a predetermined amount of time, e.g., 1 full second. Alternatively, the user can press any of those keys immediately followed by the pound (“#”) key. The telephonic server carrying out the telephone call through the prepaid service associates the most recently dialed number with that key, e.g., with the 1 key in this illustrative example. The telephonic server also automatically associates each dialed number with the 9 key, making the 9 key represent a redial of the most recently dialed number.

In a subsequent call, the user can speed dial that previously stored telephone number by simply pressing and holding the associated key, e.g., the 1 key in this illustrative embodiment, for the predetermined amount of time. Alternatively, the user can press the 1 key followed by the pound key. In response, the telephonic server places a call to the telephone number previously associated with the 1 key.

Thus, a single key press or even just two key presses are required (i) to store a most recently dialed telephone number for subsequent speed dialing and (ii) to place a call to such a previously recorded telephone number associated with the user's account. As this account is not limited to any telephone equipment or any telephone line, this speed dialing is available to the user through any telephone equipment and any telephone line.

### BRIEF DESCRIPTION OF THE DRAWINGS

FIG. 1 is a logic flow diagram of authentication in a telephone service in accordance with the present invention.

FIG. 2 is a logic flow diagram of authorization in a telephone service in accordance with the present invention.

FIG. 3 is a logic flow diagram of speed dial recall and dialing in a telephone service in accordance with the present invention.

FIG. 4 is a logic flow diagram of speed dial storage in a telephone service in accordance with the present invention.

FIG. 5 is a logic flow diagram of additional menu processing in a telephone service in accordance with the present invention

### DETAILED DESCRIPTION

In accordance with the present invention, a telephonic server which provides prepaid and perhaps other telephone services to remotely located users also provides speed dialing services to those users. The prepaid services as associated with temporary user accounts represented by a numeric passcode. The passcode (sometimes referred to as a personal identification number, i.e., “PIN”) is often associated with a predetermined cash value, e.g., $10, and sold for that amount at retail establishments.

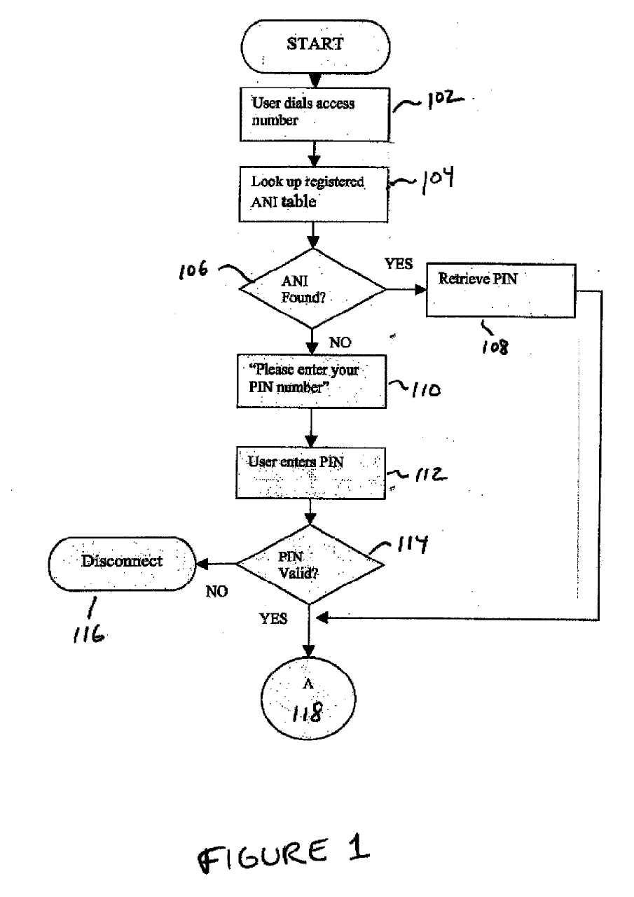

In FIG. 1, a user of ordinary telephone equipment dials an access number associated with a subject passcode in step 102. The access number is provided with the passcode when the passcode is given to the user. The dialing of the access number connects the user through the PSTN (public switched telephone network) to the telephonic server which implements an interactive voice response (IVR) server with which to interact with the user. In addition, the access number is a number for which the passcode is a secret authentication token. The access number and the subject passcode collectively and uniquely identify one of numerous accounts managed by the telephonic server, and that account is sometimes referred to herein as the “subject account.”

In this telephonic server, the user is permitted to associate one or more telephone numbers with the account such that entry of the passcode is not required to place calls under the user's account. In step 104, the telephonic server retrieves ANIs (Automatic Number Identification - i.e., telephone numbers) listed as registered for the subject account.

If, in test step 106, the telephonic server determines that the ANI of the telephone equipment from which the user is calling is registered for the temporary account, the telephonic server retrieves the passcode for the subject account and the user is authenticated in state 118. Conversely, if the ANI of the calling telephone equipment is not registered, processing transfers to step 110.

In step 110, the telephonic server prompts the user, in an IVR dialog, to “Please enter your PIN number.” In step 112, the telephonic server receives the passcode represented by Dual Tone Multiple Frequency (DTMF) signals generated by physical pressing of telephone keys by the user.

In test step 114, the telephonic server determines whether the received passcode matches the passcode of the subject account. If so, the user is authenticated in state 118. If not, the user is disconnected in step 116.

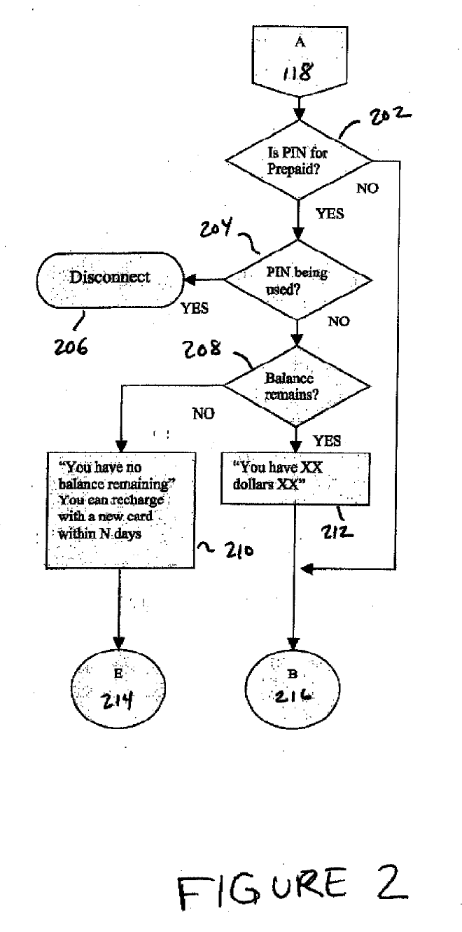

Referring to FIG. 2 representing authorization, the telephonic server determines whether the subject account is a prepaid account in test step 202. If not, pre-authorization is not required and the user is authorized in state 216. If so, processing transfers to test step 204.

In test step 204, the telephonic server determines whether the subject account is active, i.e., is associated with a properly distributed passcode. If not, the user is disconnected in step 206. If the subject account is active, processing transfers to test step 208.

In test step 208, the telephonic server determines whether the subject passcode has any remaining balance, e.g., if telephone services remain after deducting telephone services provided from the original amount of telephone services associated with the subject account. If not, the telephonic server tells the user in the IVR dialog that the user has no balance remaining and is able to reauthorize the same account with a new purchased passcode within a predetermined number of days and proceeds to a reauthorization state 214. Conversely, if the subject passcode has a remaining balance, processing transfers from test step 208 to step 212 in which the telephonic server communicates the user the amount of the remaining balance within the IVR dialog.

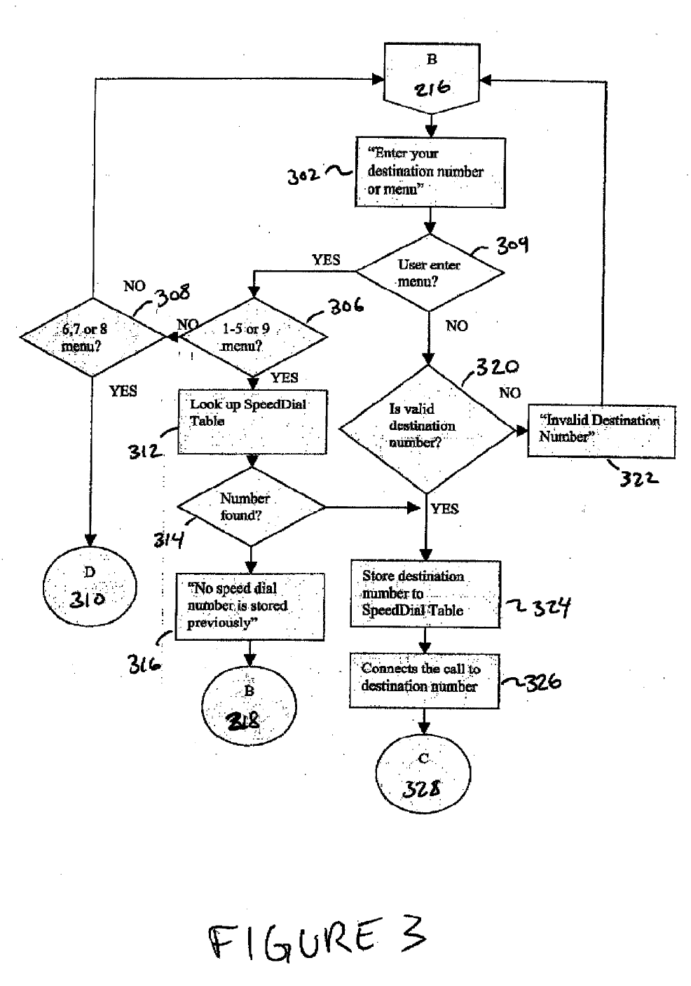

After step 212, processing transfers to an authorized state 216, which is also shown in FIG. 3.

In step 302, the telephonic server prompts the user to enter a destination telephone number or menu selection in the IVR dialog and receives DTMF signals from the user in response. In this illustrative embodiment, menu selections are represented by either elongated DTMF signals for a single key (e.g., in response to the user holding down a numeric key for a full one or two seconds) or DTMF signals representing a single numeric key followed by the pound (“#”) key. A destination number is a valid telephone number followed by the pound key.

In test step 304, the telephonic server determines whether the user entered a menu selection or a destination number. If the user entered a destination number, processing transfers to step 320 which is described below. Conversely, if the use entered a menu selection, processing transfers to test step 306.

In test step 306, the telephonic server determines whether the menu selection was a 1, 2, 3, 4, 5, or 9, corresponding to the 1, 2, 3, 4, 5, and 9 keys, respectively, on the user's telephonic equipment. In this illustrative embodiment, keys 1-5 are associated with user-specified speed-dial numbers and key 9 is associated with a last-number redial. Keys 6-8 are associated with other menu options unrelated to speed dialing. If the menu selection was not a 1, 2, 3, 4, 5, or 9, processing transfers to test step 308 which is described below. Conversely, if the menu selection was a 1, 2, 3, 4, 5, or 9, the menu selection pertains to speed dialing and processing transfers to step 312.

In step 312, the telephonic server retrieves a telephone number previously stored in association with the menu selection, i.e., one of keys 1, 2, 3, 4, 5, or 9. The storage of a telephone number in association with a particular key is described below in greater detail. In test step 314, the telephonic server determines whether any number is associated with the menu selection. If so, processing transfers to step 324 which is described below. Conversely, if no telephone number is associated with the menu selection, processing transfers to step 316 in which the telephonic server communicates that no such number is stored to the user through the IVR dialog and processing by the telephonic server returns to authorized state 218.

As described above, processing transfers to test step 308 if the user enters a menu selection that is not 1-5 or 9. In test step 308, the telephonic server determines whether the menu selection is a 6, 7, or 8, corresponding respectively to keys 6-8 on the user's telephone equipment. If not, the menu selection is not recognized by the telephonic server and processing returns to authorized state 218. Conversely, if the menu selection is a 6, 7, or 8, processing by the telephonic server enters an administration state 310 which is described below.

As described above, processing transfers to test step 320 when the user has entered a telephone number to dial rather than a menu selection. In test step 320, the telephonic server determines whether the entered number is a valid telephone call destination number. If not, processing transfers to step 322 in which the telephonic server informs the user through the IVR dialog that the telephone destination number was invalid and then returns to authorized state 218.

Conversely, if the dialed telephone destination number is valid, process transfers from test step 320 to step 324. In addition, as described above, processing transfers to step 324 from test step 314 is a telephone number is successfully retrieved for the menu selection made by the user. Thus, at step 324, the telephonic server has an intended destination telephone number, whether manually dialed or retrieved from memory.

In step 324, the telephonic server stores the telephone number in persistent memory and associates the telephone number with the subject account and with the menu selection of 9, representing a last-number redial. Thus, menu selection 9 is always associated with a last-number redial whether the number was manually entered by the user or recalled from a previously stored number associated with the subject account.

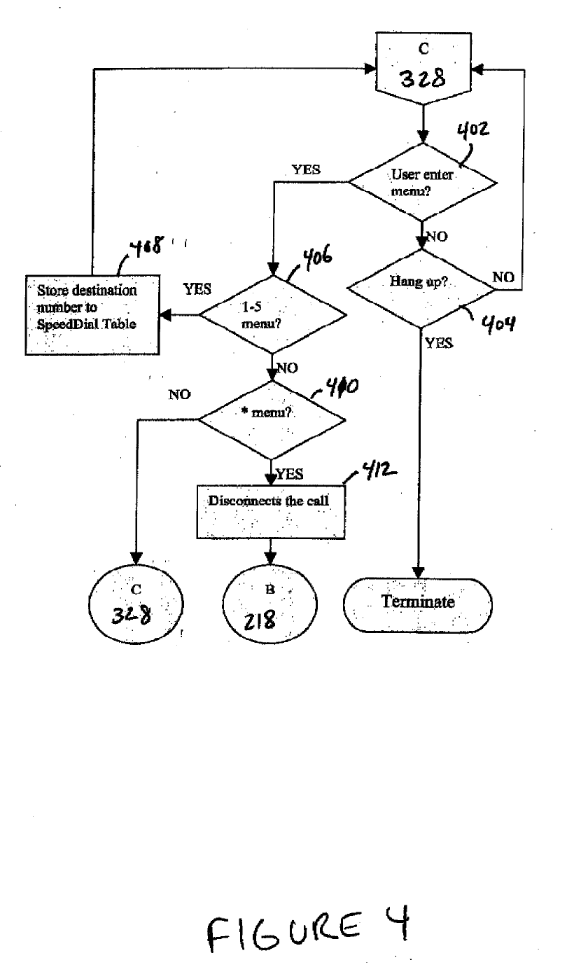

In step 326, the telephonic server connects the call from the user to the specified destination telephone number, whether manually entered or retrieved from storage of the telephonic server. Thus, when the user presses and holds any of keys 1-5 and 9 (or, alternatively, presses the single numeric key followed by the pound key), a previously stored telephone number is automatically used to connect the user to a pre-programmed destination number. Such brings the convenience of speed dialing to a telephone service account which is initially not associated with any end-user telephone equipment. Once the call is connected, processing by the telephonic server enters a connected state 328, which is also shown in FIG. 4.

From connected state 328, the telephonic server traps any events other than normal voice communications and processes each such event starting with test step 402. In test step 402, the telephonic server determines whether the trapped event is a menu selection. If not, processing transfers to test step 404 in which the telephonic server determines whether the trapped event is an on-hook condition, i.e., whether the user hung up the telephone. If so, processing of the call from the user is terminated by the telephonic server and the value of the telephone services provided by the call are deducted from the subject account. Conversely, if the trapped event is not an on-hook condition, something other than an on-hook condition (test step 404) or a menu selection (test step 402) occurred and is ignored - processing returns to connected state 328.

If, in test step 402, the trapped event is a menu selection, processing transfers to test step 406. In test step 406, the telephonic server determines whether the menu selection is 1, 2, 3, 4, or 5. If so, processing transfers to step 408 in which the telephonic server stores the destination number, which was stored and associated with the 9 menu selection in step 324 above, and associates that destination number with the menu selection—e.g., 1, 2, 3, 4, or 5. From step 408, processing returns to connected state 328.

If, in test step 406, the menu selection is not 1, 2, 3, 4, or 5, processing transfers to test step 410. In test step 410, the telephonic server determines whether the trapped event is an asterisk menu selection. If so, the telephonic server disconnects the telephone call that was connected in step 326 and processing returns to authorized state 218. Conversely, if the trapped event is not an asterisk menu selection, processing returns to connected state 328.

Thus, at any time during the call to the destination number, the user can associate the destination number with any of keys 1-5 by pressing and holding a selected one of keys 1-5 for a second or two or, alternatively, by pressing the selected key followed by the pound key. The destination can then later be recalled for speed dialing in the manner described above with respect to FIG. 3.

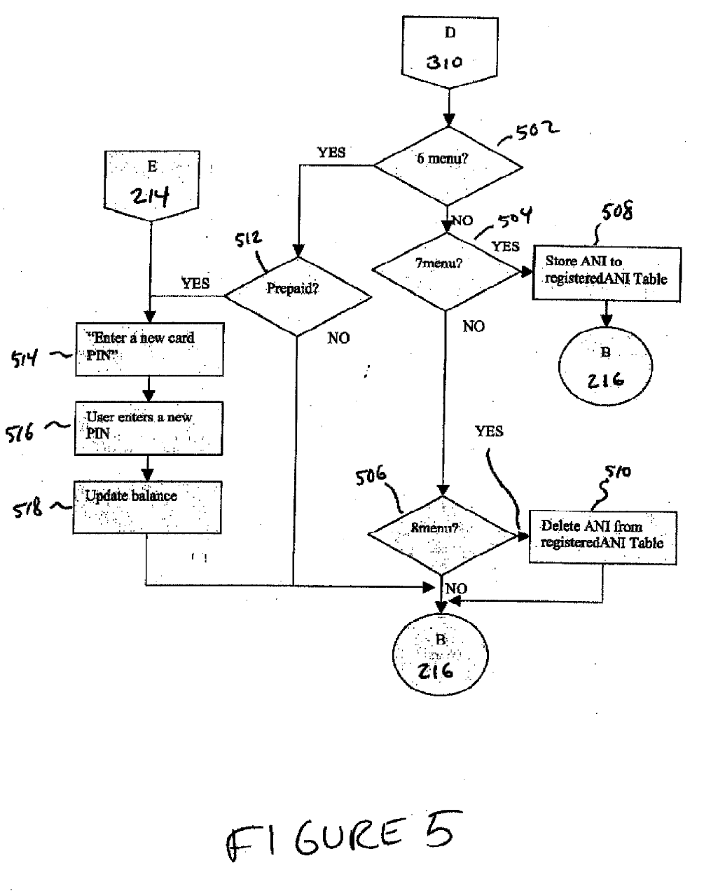

Processing in administration state 310 is shown in FIG. 5. Test steps 502, 504, and 506 recognize menu selections of 6, 7, and 8, respectively.

If the menu selection is a 7, processing transfers through test step 504 to step 508. In step 508, the telephonic server records the ANI of the current call as authorized to place calls in the subject account without specifying the passcode. If the menu selection is an 8, processing transfers through test step 506 to step 510. In step 510, the telephonic server removes any record of the ANI of the current call as authorized to place calls in the subject account without specifying the passcode. After step 508 or step 510, processing according to the telephonic server returns to authorized state 216.

A menu selection of 6 represents an attempt by the user to add additional money to a prepaid account. If the menu selection is a 6, processing transfers through test step 502 to test step 512. In test step 512, the telephonic server determines whether the subject account is a prepaid account. If not, there's no reason to add money to the subject account and processing returns to authorized state 216. Conversely, if the subject account is prepaid, processing transfers from test step 512 to step 514. In addition, processing transfers from step 210 (FIG. 2) to step 514 (FIG. 5).

In step 514, the telephonic server prompts the user to enter a new passcode through the IVR dialog. In step 516, the user enters a new passcode, e.g., purchased at retail, through the IVR dialog. In step 518, the telephonic server increases the balance of the subject account by the amount associated with the newly entered passcode. From step 518, processing returns to authorized state 216.

The above description is illustrative only and is not limiting. Instead, the present invention is defined solely by the claims which follow and their full range of equivalents.

What is claimed is:

1. A method comprising:
receiving user-generated signals representing a telephone number to connect in association with a prepaid telephone account;
receiving store signals that are user-generated and that represent at most two user input gestures;
in response to the store signals, storing the telephone number in association with the prepaid telephone account.

2. The method of claim 1 further comprising:
subsequent to storing the telephone number, receiving recall signals that are user-generated and that represent at most two user input gestures;
in response to the recall signals, retrieving the telephone number; and
connecting a call to the telephone number.

3. The method of claim 1 wherein receiving store signals is performed during a connected telephone call to the telephone number.

4. A method comprising:
receiving registration signals that are user-generated and that represent at most two user input gestures;
in response to the registration signals, storing a telephone number from which the registration signals are received as a registered originating telephone number in association with the prepaid telephone account.

5. A method comprising:
receiving de-registration signals that are user-generated and that represent at most two user input gestures;
in response to the de-registration signals, removing a telephone number from which the registration signals are received as a registered originating telephone number in association with the prepaid telephone account.

6. A method comprising:
receiving refill signals that are user-generated and that represent at most two user input gestures and that are associated with an account for which an authorized amount of telecommunications services are authorized;
in response to the refill signals:
receiving passcode signals that are user-generated and that identify an additional amount of telecommunications services;
increasing the authorized amount of telecommunications services by an amount corresponding to the additional amount.
